(19) United States
(12) Patent Application Publication
(10) Pub. No.: US 2013/0182183 A1
(43) Pub. Date: Jul. 18, 2013

(54) Hardware-Based, Client-Side, Video Compositing System

(71) Applicant: PANOPTO, INC., Seattle, WA (US)

(72) Inventors: Timothy R. Sullivan, Redmond, WA (US); Eric L. Burns, Seattle, WA (US); William Guttman, Pittsburgh, PA (US); Jesse Rice Vernon, Seattle, WA (US)

(73) Assignee: PANOPTO, INC., Seattle, WA (US)

(21) Appl. No.: 13/737,996

(22) Filed: Jan. 10, 2013

Related U.S. Application Data
(60) Provisional application No. 61/586,801, filed on Jan. 15, 2012.

(51) Int. Cl. H04N 5/262

(52) U.S. Cl. CPC H04N 5/262
USPC 348/584

(57) ABSTRACT

A system for video compositing is comprised of a storage device for storing a composite timeline file. A timeline manager reads rendering instructions and compositing instructions from the stored file. A plurality of filter graphs, each receiving one of a plurality of video streams, renders frames therefrom in response to the rendering instructions. A uniform resource locator (URL) incorporator generates URL based content. Hardware is responsive to the rendered frames, URL based content, and compositing instructions for creating a composite image. A frame scheduler is responsive to the plurality of filter graphs for controlling a frequency at which the hardware creates a new composite image. An output is provided for displaying the composite image. Methods of generating a composite work and methods of generating the timeline file are also disclosed. Because of the rules governing abstracts, this Abstract should not be used to construe the claims.

### CROSS REFERENCE TO RELATED APPLICATIONS

This disclosure claims priority to U.S. Provisional Patent Application No. 61/586,801, filed on Jan. 15, 2012, the entirety of which is herein incorporated by reference.

This disclosure is related to U.S. Pat. No. 8,306,396, filed on Jul. 20, 2006, entitled “Hardware-Based, Client-Side, Video Compositing System,” and to U.S. patent application Ser. No. 11/634,441, filed on Dec. 6, 2006, entitled “System and Method for Capturing, Editing, Searching, and Delivering Multi-Media Content,” both of which are herein incorporated by reference in their entirety.

### BACKGROUND

The present disclosure is generally directed to video editing systems and, more particularly, to a system and method for creating a composite video work.

Traditional non-linear digital video editing systems create output clips frame-by-frame, by reading input clips, performing transformations, rendering titles or effects, and then writing individual frames to an output file. This output file must then be streamed to media consumers.

There are several problems with this approach. First, to splice multiple videos together into an edited video, all video files must be stored locally, and must be of sufficiently high quality that recompression for re-streaming will not result in noticeable quality loss. Second, when the edited video is created, it must be stored in addition to the input clips, and that consumes video space proportional to its length. Creating multiple edits of the same input videos consumes additional storage. This makes mass customization impractical. Third, when the input videos are composited to create the output video, every frame of the output must be rendered at the exact frame size and format of the output video. This requires that input videos using different resolutions, color spaces, and frame-rates be upscaled, downscaled, color-space converted, and/or re-timed to match the output media type. Finally, even if the original videos are available via network streams, delivering the edited output video to a consumer requires that the output video be hosted (served on a network) as well.

There is a technology component in Windows XP® software called the Video Mixing Renderer 9 (VMR9), part of the DirectShow® API. In DirectShow®, all streaming media files are played by constructs called “filter graphs,” in which a directed graph is created of several media “filters.” For example: This graph might start with a “file reader filter” (or a “network reader filter,” in a network streaming case) to define an AVI input stream of bits (from disk or network, respectively). This stream then passes through an AVI splitter filter to convert the AVI format file into a series of raw media streams, followed by a video decoder filter to convert compressed video into uncompressed RGB (or YUV) video buffers, and finally a video renderer to actually draw the video on the screen.

The Microsoft VMR9 is a built-in proprietary video renderer that draws video frames to Direct3D® hardware surfaces. A “surface” is an image that is (typically) stored entirely in ultra-high-performance graphics controller memory, and can be drawn onto one or more triangles as part of a fully hardware-accelerated rendering pipeline. The primary goal of the VMR9 is to allow video to be rendered into these surfaces, then delivered to the application hosting the VMR9's filter graph for inclusion in a Direct3D® rendered scene. The advantage of this approach is that many highly cpu-intensive operations, such as de-interlacing the output video, re-sizing it (using bilinear or bicubic resampling), color correcting it, etc., are all performed virtually for free by modern consumer graphics hardware, and most of these operations are complete before the video surface even becomes available to the application programmer.

The VMR9 has a mode of operation called “mixing mode,” in which a small number of video streams can be “mixed,” or composited, together at rendering time. The streams can vary in frame size, frame rate, and other media-type parameters. When frames are issued to the renderer by upstream filters (such as the compressed video decoder), it composites the frames together and generates a single Direct3D® surface containing the composite. The user can control alpha channel values, source and destination rectangles for each input video stream.

There is a significant deficiency to this approach, beyond the simple issue that the performance of the compositing operation tends to be poor: DirectShow® requires that all input streams to the VMR9 be members of the same filter graph, and thus must all share the same stream clock. This sharing of the stream clock means that if several different video clips are all rendered to inputs on a single VMR9, and the filter graph is told to seek to 1:30 on its media timeline, each video clip will seek to 1:30. The same holds for playback rate; it is not possible to change the playback rate (for example, 70% of real-time) for one stream without changing it for all streams. Finally, one stream cannot be paused, stopped, or rewound independently of the others.

Suppose that a user wants to create an edited video that consists entirely of streaming video currently available on the Internet (or a private sub-network or local disk), while adding his own effects, transitions, and titles, and determining exactly which subsections of the original files he would like to include in the output. Such an operation is essentially impossible today: as described above, the user would need to obtain editable, local copies of each input video, then render the output frame-by-frame using a nonlinear video editor, and finally, compress it and re-stream it for delivery to his audience. Even if the compositing features of the existing VMR9 were leveraged to provide simple alpha blending, movement effects, and primitive transitions, the input videos would all still play on the same stream clock and thus the user would not have control over the timelines of the input videos with respect to the output video.

### BRIEF SUMMARY OF THE DISCLOSURE

The present disclosure is directed to a system for video compositing, which is comprised of a storage device for storing a composite timeline file. A timeline manager reads rendering instructions and compositing instructions from the stored file. A plurality of filter graphs, each receiving one of a plurality of video streams, renders frames therefrom in response to the rendering instructions. A uniform resource locator (URL) incorporator generates URL based content. Hardware is responsive to the rendered frames, URL based content, and compositing instructions for creating a composite image. A frame scheduler is responsive to the plurality of filter graphs for controlling a frequency at which the hardware creates a new composite image. An output is provided for displaying the composite image.

The present disclosure is also directed to a system for video compositing, which is comprised of a storage device for storing a composite timeline file. A timeline manager reads the stored timeline file to identify rendering instructions and compositing instructions. A plurality of software filter graphs, each having a rendering module, receive one of a plurality of video streams and render frames therefrom in response to the rendering instructions. A uniform resource locator (URL) incorporator generates URL based content. Hardware responsive to the plurality of filter graphs, timeline manager, and URL incorporator creates a composite image in response to the rendered frames, URL based content, and compositing instructions. A frame scheduler responsive to the plurality of filter graphs commands the hardware to create a new composite image when any of the filter graphs renders a new frame. An output is provided for displaying the composite image.

The present disclosure is also directed to a method for video compositing which is comprised of reading rendering instructions and compositing instructions from a timeline file, rendering frames from a plurality of video streams in response to the rendering instructions, generating uniform resource locator (URL) based content, creating a composite image from the rendered frames, URL based content, and compositing instructions, controlling a frequency at which a new composite image is created in response to the rate at which rendering is occurring, and displaying the composite image.

The hardware-based, client-side, video compositing system of the present disclosure aggregates multiple media streams at a client host. The network streams could be stored locally or, more typically, originate from ordinary streaming media sources on the network. The result of the aggregation is an audio/visual presentation that is indistinguishable from a pre-compiled edited project, such as might be generated by traditional editors, such as Adobe Premier. However, a major difference is that the system of the present disclosure does not require the content creator of the composite work to have access to source materials in original archival form, such as high bit-rate digital video. Indeed, the content creator of the composite work can use any available media streams as source material.

### BRIEF DESCRIPTION OF THE FIGURES

The present disclosure will now be described, for purposes of illustration and not limitation, in conjunction with the following figures wherein:

FIG. 1 is a block diagram of an example hardware-based, client-side, video compositing system constructed according to the teachings of the present disclosure.

FIG. 2 is a block diagram of a filter graph of the type which may be used in the system of FIG. 1.

FIG. 3 is an example of a screen shot from a commercial, nonlinear editing system.

FIG. 4 is a block diagram of another example hardware-based, client-side, video compositing system.

FIG. 5 is a flowchart depicting an example method for adding a URL event to a composite video work.

FIG. 6 depicts an example modal dialog window for adding a new event to a composite video work and for associating a URL with the new event.

FIG. 7 depicts loading of a URL based event within a viewer used to display a composite video work.

FIGS. 8A, 8B, and 8C depict example systems for video compositing.

### DETAILED DESCRIPTION

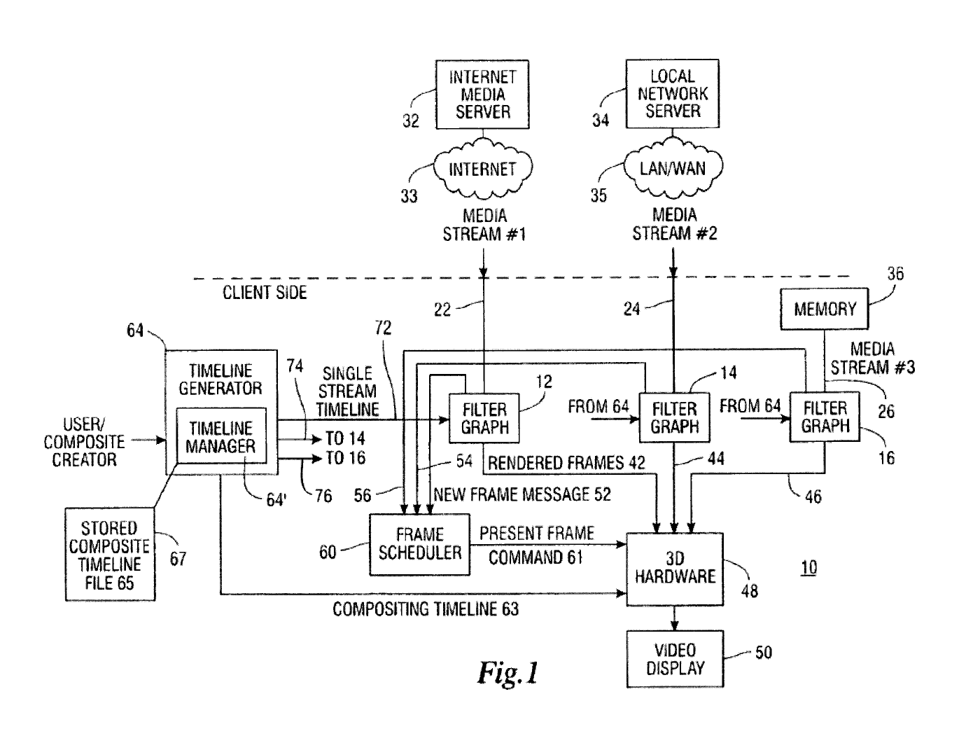

FIG. 1 is a block diagram of an example hardware-based, client-side, video compositing system 10 constructed according to the teachings of the present disclosure. The system 10 is comprised of a plurality of filter graphs, three in this example (filter graphs 12, 14, 16) one for each of the media streams 22, 24, 26, respectively. In this example, the first media stream 22 is streaming video delivered from an Internet media server 32 via the Internet 33. The second media stream 24 is also streaming video delivered from a local network server 34 via a local area network or wide area network 35. The third media stream 26 is taken from a video file being read from a local memory device 36. In general, the media streams can be any media that is delivered in a time-based manner. That includes video streams such as Windows Media, MPEG streams, among others, audio streams, markup streams (e.g., ink, time stamped slide shows (Power Point, PDF, among others), etc.

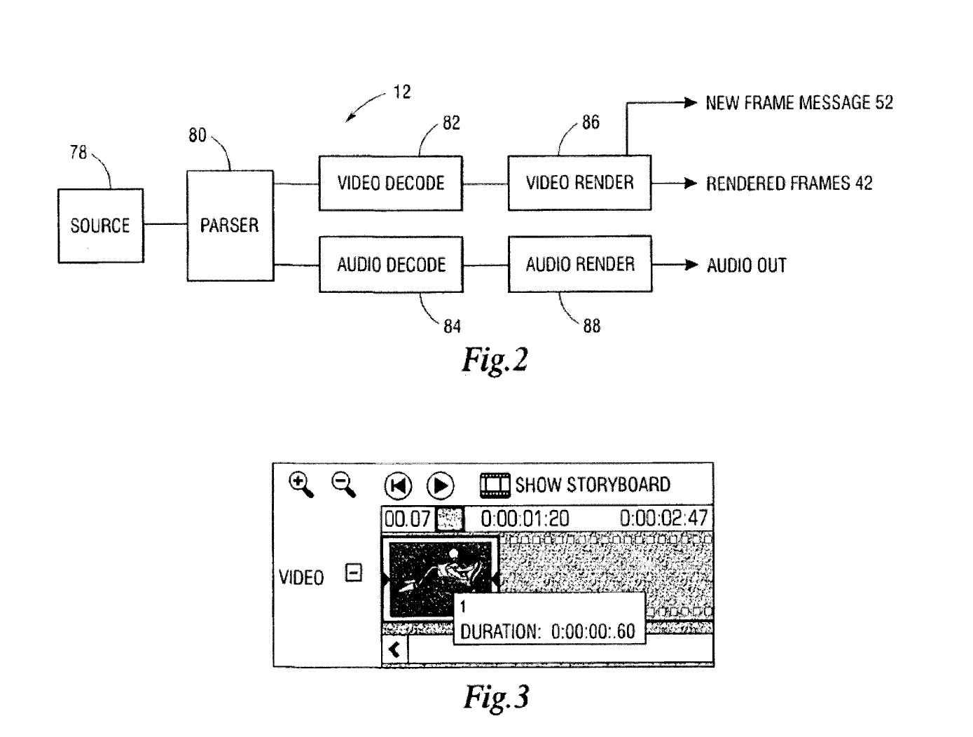

The filter graphs 12, 14, 16 produce rendered frames 42, 44, 46 and new frame messages 52, 54, 56, respectively, as is discussed in detail below in conjunction with FIG. 2. The rendered frames are available to 3D hardware 48. The 3D hardware 48 is conventional hardware, such as nVidia GeForce™, ATI Radeon™, among others, which manages the mapping of off-screen surfaces to an on-screen composite work. The composite work could include any number of the media streams 22, 24, 26 arranged on a timeline according to user-generated instructions, as will be explained below. The on-screen composite work is displayed on a video display 50.

The new frame messages 52, 54, 56 are input to a frame scheduler 60. The frame scheduler 60 is a software component that sends a “present frame” command 61 to the thread managing the 3D hardware 48 whenever the frame scheduler receives one of the new frame messages 52, 54, 56. The “present frame” command 61 may take the form of a flag which, when set, causes the 3D hardware to refresh the composite work in the pixel buffer (not shown) of the video display 50 according to compositing instructions in compositing timeline 63. The frame scheduler may be implemented through a messaging loop, a queue of events tied to a high-precision counter, event handles, or any other sufficiently high-performance scheduling system. The basic purpose of the frame scheduler is to refresh the video image on the screen whenever any input video stream issues a new frame to any of the video renderers.

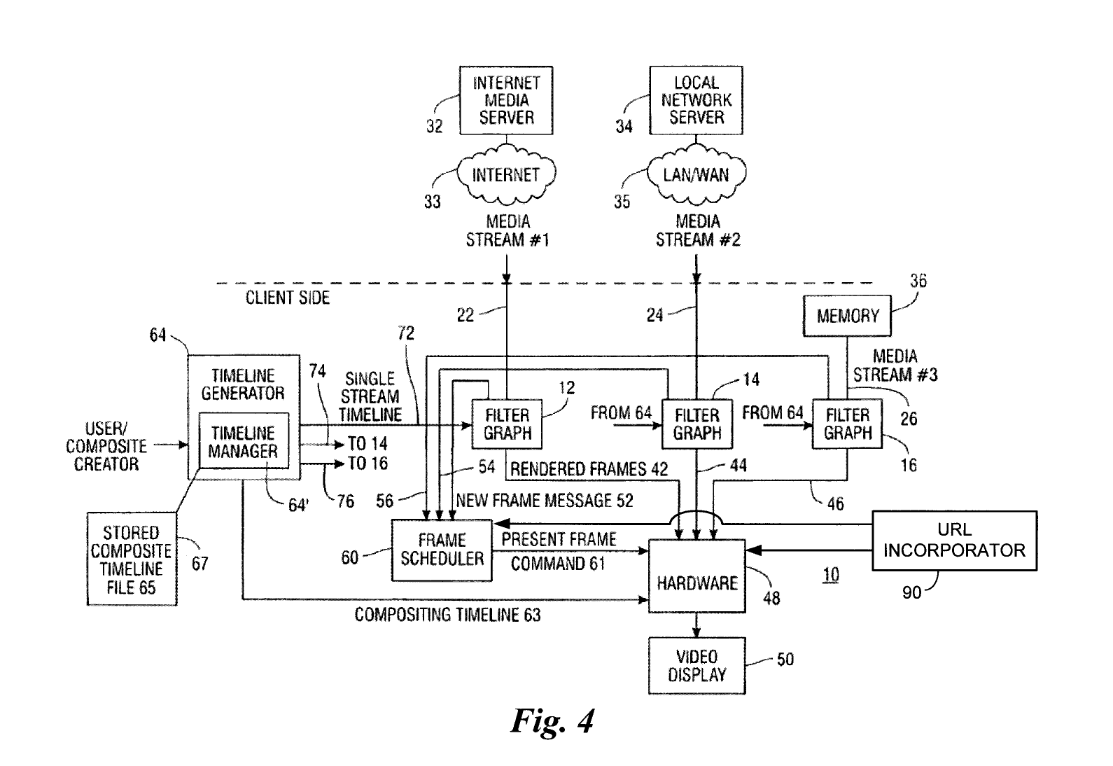

A compositing timeline generator 64 produces a compositing timeline file 65 which is stored in memory device 67. Generic video editing timeline generators are known in the art and include products, such as Adobe Premiere, Apple iMovie®, Microsoft Movie Maker, etc., a screen shot from one of which is shown in FIG. 3. Timelines generated by these products are used to create static, pre-rendered output files, as described earlier in this document, and are mentioned only to illustrate the source video subselection and type of effects, transitions, titles, etc. that might be included in a client-side compositing timeline. The compositing timeline generator 64 allows a user, which in this case is the creator of the composite work, to orchestrate when and how each of the media streams 22, 24, 26 will appear, if at all, in the composite work. The resulting set of instructions is the compositing timeline file 65 which is a computer-readable set of instructions that is used by a time line manager 64′ to guide the creation of the composite work from the various media streams 22, 24, 26. The instructions can be meta-data that identify which segments of a media stream are to be part of the composite work, along with the intended time alignments and presentation rates of those segments within the composite work. The instructions can also identify transitions, text and other generated displays, or other information. The instructions can also identify synthetic content, such as effects (e.g., flipping, folding, morphing, among others), transitions (e.g., fade, alpha-blend, wrap, among others), rendered objects (e.g., locally generated text, titles, images, among others), etc. There may be multiple instructions for any given instant in the composite work. The compositing timeline file 65 may be thought of as a fast-memory representation of instructions that maps a single instant of an intended composite work to the instructions for generating the visual representation of that instant.

One example for achieving computer readability is to use an XML-based representation. There are many possibilities, and the present disclosure is not limited by the particular details of how the timeline might be represented. The content can include many kinds of instructions, as previously mentioned. Some examples for a particular media stream could include:
Start time within the media stream;
End time within the media stream;
Start time in the composite work;
End time for the composite; and
Speed-up or slow-down for the composite work relative to the pace of the media stream. This could also be inferred from the ratio of the relative durations of the media stream and composite work.

The following are some examples for transition effects from one media stream to another which can be implemented through appropriate instructions in the compositing timeline file 65. Some of these involve multiple streams appearing simultaneously in the composite work:
Dissolve, fade, and other effects for transition;
Picture-in-picture; and
Tiling.
Examples of effects within a media stream may include distortion, morphing, tessellation, and deformation, among other 3D-based effects.

The following are some examples of effects and displays based on non-stream input, which can be implemented through appropriate instructions in the compositing timeline file 65:
Title text, shapes, and other locally generated content displayed directly;
Locally generated content displayed as an overlay on media stream or other image; and
Animated title text or other locally generated content.

To illustrate what a compositing timeline file 65 might look like, an XML file is presented with some example instructions. This is not a comprehensive set of examples.

```
<compositeProject>
      <videoSegment>
            <name>Video 1</name>
            <id>1</id>
            <url>http://server.org/video1.asf</url>
            <inputStart>1:00</inputStart>
            <inputEnd>2:00</inputEnd>
            <outputStart>0:00</outputStart>
            <outputEnd>1:00</outputEnd>
      </videoSegment>
      <videoSegment>
            <name>Video 2</name>
            <id>2</id>
            <url>http://server.somewherelse.org/video2.asf</url>
            <inputStart>5:00</inputStart>
            <inputEnd>8:00</inputEnd>
            <outputStart>0:30</outputStart>
            <outputEnd>6:00</outputEnd>
      </videoSegment>
      <videoSegment>
            <name>Video 3</name>
            <id>3</id>
            <url>c:\mycomputer\video3.asf</url>
            <inputStart>0:00</inputStart>
            <inputEnd>0:30</inputEnd>
            <outputStart>5:00</outputStart>
            <outputEnd>6:00</outputEnd>
      </videoSegment>
      <transition>
            <startTime>0:30</startTime>
            <endTime>1:00</endTime>
            <startID>1</startID>
            <endID>2</endID>
            <type>DISSOLVE</type>
      </transition>
      <transition>
            <startTime>3:00</startTime>
            <endTime>6:00</endTime>
            <startID>2</startID>
            <endID>3</endID>
            <type>PIP</type>
      </transition>
      <effect>
            <startTime>2:00</startTime>
            <endTime>4:00</endTime>
            <effectType>SHIMMER</effectType>
            <targetID>ALL</targetID>
      </effect>
      <title>
            <startTime>0:00</startTime>
            <endTime>0:30</endTime>
            <titleType>SERIF30</titleType>
            <content>Our example!</content>
      </title>
</compositeProject>
```

Returning to FIG. 1, three, single, stream-specific timelines 72, 74, 76 are output from the global timeline manager 64′ to the filter graphs 12, 14, 16, respectively. The global timeline manager 64′ may be thought of as that part of the compositing code that reads the timeline file 65, then provides instructions and/or data to the various filter graphs 12, 14, 16 on which sections of the input streams should be played (and at what rates and time alignment, discussed below), and provides instructions to the code controlling the 3D hardware 48 about which of the video frames currently being rendered by the filter graphs should be combined and manipulated. The global timeline manager 64′ is shown as part of the timeline generator 64 but could be implemented in stand-alone code.

The presentation rate is an adjustment made to the relative display speed of a media stream of a video file and the result that appears in the composite work. The time alignment is the correspondence of the start time of the timeline of a segment of video with a point in the overall timeline of the composite work.

Note that from only metadata, such as input video source and time code range, transition type and duration, title text and formatting information, etc., it is possible to construct the compositing timeline file 65 containing the information and instructions needed to generate the desired composite work. The composite work is generated in real time and within the 3D hardware 48 on the client system 10, rather than offline and pre-processed. There is no pre-existing copy of the composite work, as it is built on the fly. To regenerate the composite work, or to share it with others, only the small compositing timeline file 65 needs to be shared, and that can be easily accomplished by posting it on a web site or sending it via email.

Turning now to FIG. 2, FIG. 2 is a block diagram of the filter graph 12. The reader will understand that the other filter graphs 14, 16 are similarly constructed. The filter graph 12 illustrated in FIG. 2 is a typical playback graph for an MPEG movie file. It is comprised of a source filter 78 for reading the data from a URL or a file. A parser filter 80 is responsive to the source filter 78 and separates out portions of audio and video data. An audio decoder 84 and a video decoder 82 are responsive to the audio and video portions, respectively, separated out by the parser filter 80. Finally, a video renderer 82 and an audio renderer 88 are responsive to the video decoder 82 and audio decoder 84, respectively. The video renderer 82 produces the rendered frames 42 and the new frame message 52.

As an example of an input stream, we can use an input stream that is a high-resolution video stream (e.g., HD) created from a stationary camera of a relatively large scene, such as the entire front of a classroom. The stationary camera allows for a high compression rate in the stream. We then use the disclosed compositing technique to present only a cropped portion of this large, high-resolution image, with the size and location of the cropped area changing according to the timeline instructions. This creates the appearance of a videographer panning, tilting, and zooming, even though in reality all this is done in the video hardware of the client on the basis of instructions possibly given well after the actual capture. In other words, it enables unattended video capture with a fixed high-resolution camera and after-the-fact “videography” that can be tailored to individual users.

Having described the components of the system 10 of FIG. 1, the operation of the system 10 will now be described. First, the compositing timeline file 65 is generated by identifying those frames and/or other time-based media elements that are to be displayed in the composite work. The composite timeline file 65 can be generated in a number of ways including a separate editor application, by hand, or by some other tool. The compositing timeline file 65 also contains the instructions (compositing timeline 63) that control the presentation of the composite work, i.e., fading, tiling, picture-in-picture, etc. Once the compositing timeline file 65 is created, it may then be stored for later use and/or shared with others. Note that because the compositing timeline file 65 contains information for identifying portions of media streams rather than the portions of the media streams themselves, the compositing timeline file is a small file compared to the size of the composite work.

The process of reading the stored compositing timeline file 65 and using it to assemble frames or other time-based media elements into a resulting time-based composite work displayed on video display 50 is called compositing. The composite work is created in real time, on the fly. Note that many publicly available video streams on the Internet can be used as raw material for the synthesis of composite works. No copy of the composite work exists before it is composited, and assuming the person viewing the composite work does not make a copy during the compositing process, the composite work may be viewed as ephemeral.

The compositing is accomplished by programming each video renderer 86 within the filter graphs 12, 14, 16 to create separate surfaces in graphics hardware for their respective media streams 22, 24, 26. The frame scheduler 60 receives notification via the new frame messages 52, 54, 56 each time any frame rendered within the filter graphs 12, 14, 16 updates its surface with a new frame of video. Upon receiving the notification, the frame scheduler 60 issues the present frame command 61 that causes the 3D graphics hardware 48 to draw a “scene” (3D rendered image) consisting of some or all surfaces containing video data from the various sources. Because this is an ordinary 3D scene, the drawing algorithms are limited only by the imagination of the application designer or creator of the editing project. Effects, transitions, titles, etc. can have arbitrary complexity and are limited by the performance of the 3D graphics hardware 48.

Because each source video in this system has its own filter graph, all of the problems mentioned in connection with the prior art related to common clocks are eliminated. With respect to differing frame rates, the compositing of the present disclosure involves using the local 3D hardware 48 to redraw the entire output video frame each time a source video renderer 78 issues a new frame message 52, 54, 56 to the frame scheduler 60 (up to the maximum refresh rate of the output device). So, if one video stream were 24 fps and another were 30 fps, with a monitor refresh rate of 60 Hz, the output video would update a maximum of 60 times per second.

Finally, all problems relating to different input resolutions and color spaces are eliminated. Resolving these discrepancies is a primary reason for the complexity of traditional non-linear editing systems; when each video is first rendered into a hardware 3D surface before being drawn, the process of resolving the differences in resolution and color space becomes as simple as instructing the 3D hardware to draw a polygon to the desired region of the screen.

Using the system 10 described above, it is possible to create an editing software (e.g., timeline generator 64) that generates project files (e.g., compositing timeline files 65) composed entirely of metadata but that can be played as easily as normal video files. One can also create a player (e.g., timeline manager 64′) that interprets the compositing timeline files 65 by playing the series of remotely hosted streaming video clips, potentially on different timelines and at different rates, and performs all of the specified compositing by simply drawing the video frames as desired by the project creator.

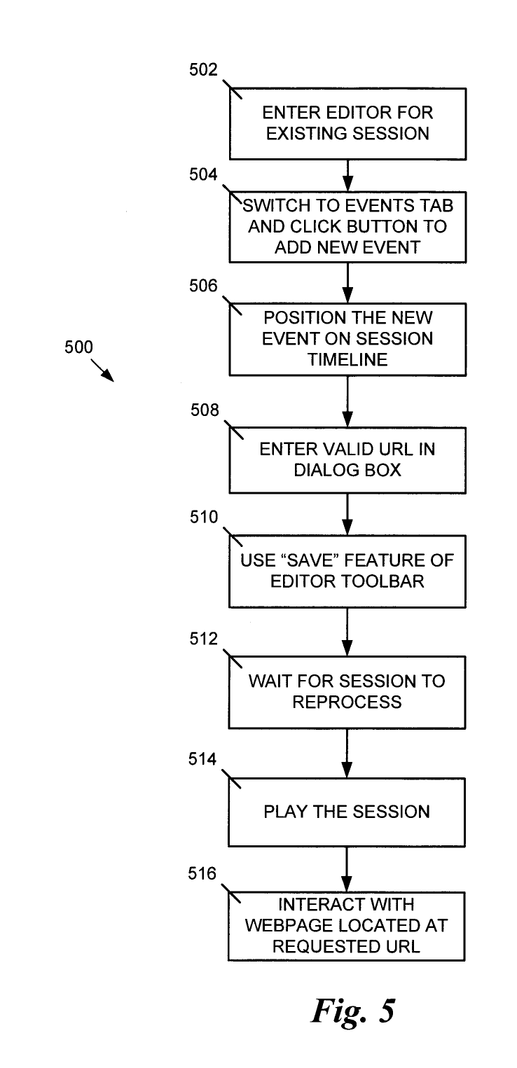

FIG. 4 is a block diagram of another example hardware-based, client-side, video compositing system 10. The system 10 includes a storage device 67 for storing a composite timeline file 65 and a timeline manager 64 responsive to the stored composite timeline file 65 for reading rendering instructions and compositing instructions of the file 65. A plurality of filter graphs 12, 14, 16 are included in the system 10, where each filter graph is used to receive one of a plurality of video streams 22, 24, 26 and to render frames 42, 44, 46 therefrom in response to the rendering instructions. The compositing system 10 further includes hardware 48 responsive to the rendered frames 42, 44, 46 and the compositing instructions for creating a composite image. A frame scheduler 60 is responsive to the plurality of filter graphs 12, 14, 16 and is used to control a frequency at which the hardware 48 creates a new composite image. An output video display 50 is used in the system 10 to display an on-screen composite video work generated based on the composite image. The compositing system 10 of FIG. 4 operates in a manner similar to that of the example system 10 of FIG. 1 and includes similar components. Thus, only those aspects of FIG. 4 that differ from FIG. 1 are discussed below.

In the system 10 of FIG. 4, a uniform resource locator (URL) incorporator 90 is used to generate URL based content that may be added to the composite image and to the on-screen composite work. In the example system 10 of FIG. 4, the URL incorporator 90 is coupled to the hardware 48 and supplies the generated URL based content to the hardware 48. Thus, in generating the composite image, the hardware 48 may be responsive to the URL based content and to the URL incorporator 90, as well as to the rendered frames 42, 44, 46 and the compositing instructions of the composite timeline file 65. The URL incorporator 90 enables the composite image and the on-screen composite work to include Hypertext Markup Language (HTML) based content and other content accessible via URL addresses (e.g., content available via hypertext transfer protocol or file transfer protocol, among other protocols, with http://, ftp://, or similar other URL addresses).

The URL incorporator 90 enables a user of the system 10 to navigate to a URL of the user's choice at a particular point in time in the composite work. Navigating to the URL enables the URL based content to be retrieved and added to the composite work. In one example, the composite work is a presentation, and the user may associate the URL with one or more events of the presentation. The one or more events of the presentation may include, for example, a display of a Powerpoint slide, a selection of a node of a table of contents, a start or finish of a particular audio or video stream, or a revealing of a textual note to a viewing audience. Alternatively, the URL may be associated with a particular point in time and may not be tied to an event. Use of the URL based content within the composite work may allow for integration of interactive or self-driven learning into an otherwise passive viewer experience.

The URL incorporator 90 may be driven by HTML or Javascript programmability, as well as other programming languages, platforms, or technologies that allow content to be accessed via a URL address (e.g., Java applets, Flash presentations, streaming video or audio, social media platforms). When a user of the system 10 (e.g., a presentation author or lecturer) chooses to include URL based content accessible by the URL incorporator 90 into a composite work (e.g., a lecture or presentation), the user selects a URL to navigate to via a user interface of the system 10 (e.g., within a particular viewer frame of the user interface). The user interface of the system 10 may expose a simple programming interface to a programming language (e.g., HTML, Javascript, etc.) of the URL based content. In one example, the URL based content may include an application, such that the user interface exposes a simple programming interface to a Javascript programming language within the application. The programming interface may provide the ability to play, pause, and seek the URL based content, the composite work, or particular aspects of the composite work (e.g., media streams 22, 24, 26). The programming interface may also provide an ability to conduct a search against data accessible via the system 10 (e.g., a corpus of data of the system 10 accessible via the Internet media server 32 or the local network server 34, etc.) and to navigate to other content accessible via the system 10.

To ensure security, the URL incorporator 90 may include a whitelist of domains that has been compiled by an administrator of the system 10. The whitelist of domains may include domains determined to be safe and secure. Thus, a URL supplied by a user of the system 10 may be checked against the whitelist, and if the supplied URL is not included in the whitelist, access to the URL may be denied. Further, the URL incorporator 90 may proxy the URL to the user via a proxy server. The use of the whitelist and/or the proxy server with the URL incorporator 90 may allow full interactivity between the programming language of the URL based content and the programming interface.

Use of the URL incorporator 90 to deliver URL based content within the composite work may be used for a variety of applications, including measuring viewer learning or comprehension via an in-lecture quiz. For this application, the composite work may be a lecture or a presentation aimed at educating the viewer. The lecture or presentation may be pre-recorded and played back on demand to the viewer. Further, the lecture may include multiple video streams (e.g., a video of the lecture, a video of a whiteboard, and a video of a lecturer's computer screen or presentation slides). At chosen points within the lecture or presentation, the lecturer may choose to automatically pause lecture playback and load a quiz application that displays an interactive interface containing a quiz for topics that have been covered in the lecture or presentation.

The quiz application or content for the quiz may be accessed by the URL incorporator 90. Thus, the system 10 may use the URL incorporator 90 to navigate to a URL that includes the quiz application, where the quiz application may be implemented as a Javascript program, interactive Flash presentation, Java applet, or other suitable technology. Alternatively, the system 10 may use the URL incorporator 90 to navigate to a URL that includes quiz content (e.g., quiz questions), such that the quiz content can be downloaded and used via a locally-accessible quiz application. Thus, the quiz application may be stored at a location accessible via a URL, or the quiz application may be stored in a variety of locations that need not be accessible via a URL (e.g., a local memory or storage device, local network, etc.). Further, in another example, neither the quiz content nor the quiz application need be accessible via a URL. When the viewer takes the quiz, the quiz application may upload the results to a server for review by the lecturer. If the viewer answers the quiz incorrectly, the quiz application may seek back to a portion of the lecture that explains the material that the viewer failed to understand. The viewer may be allowed to watch the portion of the lecture again. When the quiz is complete, the quiz application may automatically resume the lecture.

The URL incorporator 90 may be used for other example applications, including demonstrating concepts via viewer interaction or viewer experimentation. Certain lecture subjects may be more easily learned via viewer interaction or viewer experimentation (e.g., when describing the laws of thermodynamics to the viewer, it may be useful to enable access to an experimental system that allows the viewer to vary temperature, volume, and density to observe the results on a system). Using the system 10, at certain points in a lecture, the lecturer may pause lecture playback and load an experiment application that allows the viewer to interact with topics that have been discussed or will be discussed in the future. The experiment application or content for the experiment application may be accessed by the URL incorporator 90. The experiment application may be stored at a location accessible via a URL, or the experiment application may be stored in a variety of locations that need not be accessible via a URL, such that only content for the experiment application need be accessible via a URL. Further, in another example, neither the experiment application nor content for the experiment application need be accessible via a URL. The experiment application may be as simple as a single web page or as complex as a full virtual laboratory. Further, the experiment application may be completely freeform or may provide a highly-guided experience for the viewer.

Another example application of the URL incorporator 90 may include providing a self-directed learning experience. A traditional classroom learning experience may include only a single path through a selection of topics. However, a topic covered in a lecture may be closely related to multiple other topics, such that there may not be a single suitable path for exploring the topic and the related other topics. For example, a history lecture about the steel industry in the United States in the 1850's may typically only be covered in a class on the Industrial Revolution. However, a student may be more interested to cover a survey of steel production techniques throughout history. The URL incorporator 90 may allow the lecturer to access or create a navigation application to enable an interactive model between the viewer and content available via the composite work or the URL based content of the system 10. For example, when a particular portion of the lecture is complete, the navigation application can be accessed to give the viewer choices of related topics to view text. The related topics may continue with topics discussed in the lecture or may include different topics not discussed in the lecture. The navigation application or content for the navigation application may be accessed by the URL incorporator 90. The navigation application may be located at a location accessible via a URL, or the navigation application may be located in a variety of locations that are not accessible via a URL, such that only content for the navigation application need be accessible via a URL. Further, in another example, neither the navigation application nor content for the navigation application need be accessible via a URL.

Although quiz applications, experiment applications, and navigation applications are described herein, a variety of other applications may be made accessible via the URL incorporator 90. Further, there exists a possibility for a marketplace for such applications or reusable building blocks for constructing such applications. For example, in constructing a quiz application, there may be common elements shared by multiple quizzes. Rather than implementing each quiz as a standalone application, each application could re-use the common components of the quiz and specify only visual and textual elements necessary to define a particular quiz instance. The common elements could be provided by administrators of the system 10 or could be provided by third parties.

In FIG. 4, the URL incorporator 90 is connected to the frame scheduler 60. As described above, the frame scheduler 60 is coupled to the hardware 48 and may be used to control a frequency at which the hardware 48 creates new composite images. The URL incorporator 90 may be coupled to the frame scheduler 60 in order to allow the frame scheduler 60 to take into account aspects of the URL based content when controlling the frequency at which the hardware 48 creates new composite images. In other example systems, the URL incorporator 90 may not be connected to the frame scheduler 60 and may instead be connected to other portions of the system 10. Further, in other example systems, the URL incorporator 90 may be connected to the frame scheduler 60 and the hardware 48, as well as to additional other components of the system 10.

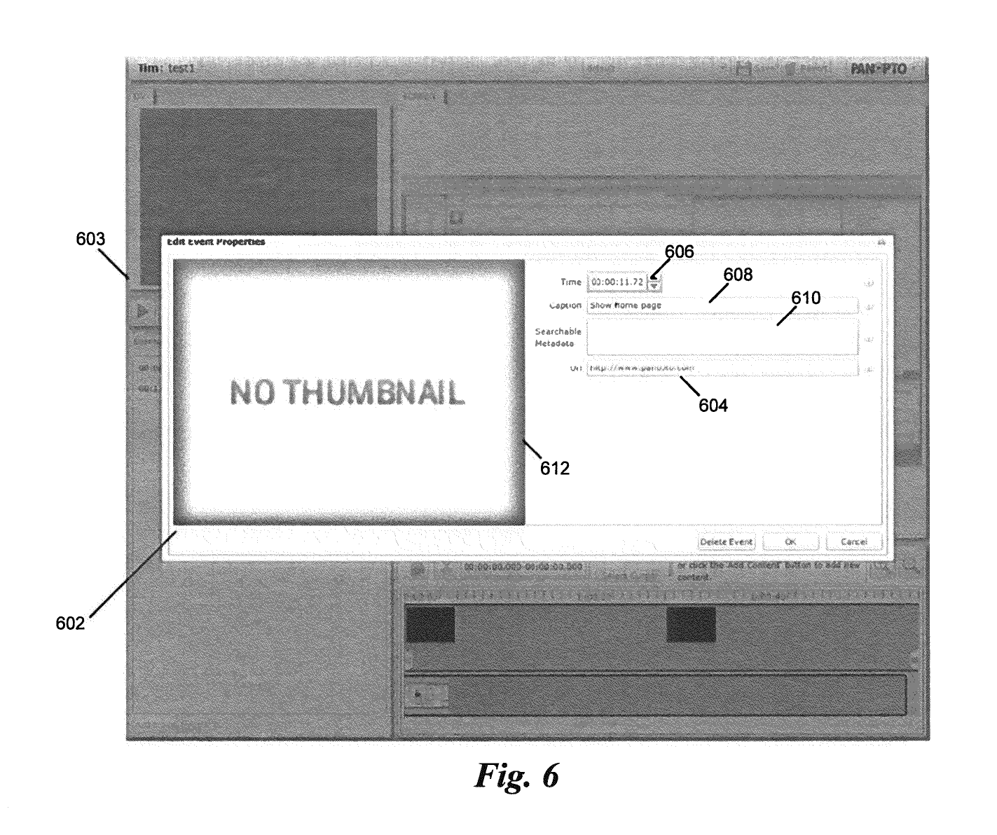

FIG. 5 is a flowchart 500 depicting an example method for adding a URL event to a composite video work. The example method described in FIG. 5 may be utilized via a URL incorporator (e.g., the URL incorporator 90 of FIG. 4) to generate URL based content for the composite video work. As described above with respect to FIG. 4, a system for creating a composite work may include a user interface that provides user input/output functions (e.g., exposing an application programming interface to allow the user to input programming commands or allowing a user to select or input a URL from which URL based content may be generated). Such a user interface may be used in adding the URL event to the composite video work, as illustrated in steps of the flowchart 500.

At 502, the user enters an editor of the user interface for an existing session. As described above, the existing session may define the composite work to which the URL based content is to be integrated. For example, the existing session may include a timeline for the composite work and instructions for enabling or disabling media streams within the composite work at certain points on the timeline. At 504, the user switches to an “events” tab of the user interface and clicks a button to add a new event. The “events” tab may include a listing of events comprising the composite work, with each of the events being associated with certain points of time on the timeline or other events of the composite work. The “events” tab further allows new events to be added to the existing listing of events, for example, by clicking the button or by another input method (e.g., via a command interface or by a drag-and-drop process). At 506, to add the new event, the user positions the new event on the session timeline (e.g., at the two minute mark of the timeline). In other examples, the new event may be associated with other events (e.g., the new event is invoked at the end of another event) or with other aspects of the composite work. At 508, a modal dialog is invoked, allowing the user to enter a valid URL in a field that is labeled “URL.” A modal dialog box or window may appear automatically following the positioning of the new event along the session timeline.

At 510, after adding the new event and associating the new event with the URL via the modal dialog box or window, a save button on the editor toolbar is clicked by the user. Alternative methods of saving the updated session may be used (e.g., keystrokes, command interface, menu system). At 512, following the saving of the updated session, reprocessing may be performed on the session, and the user may wait for the session to reprocess (e.g., the system is temporarily disabled during reprocessing). At 514, following reprocessing, the updated session may be played. When playback reaches the point in the timeline where the URL event was placed, a viewer component of the user interface or presentation software may activate a new tab (e.g., a tab labeled “URL”) and load the URL event from the requested URL within a window or portion of the composite work (e.g., within a hosted web browser window). At 516, the user or a viewer may freely interact with the URL based content that was located at the requested URL.

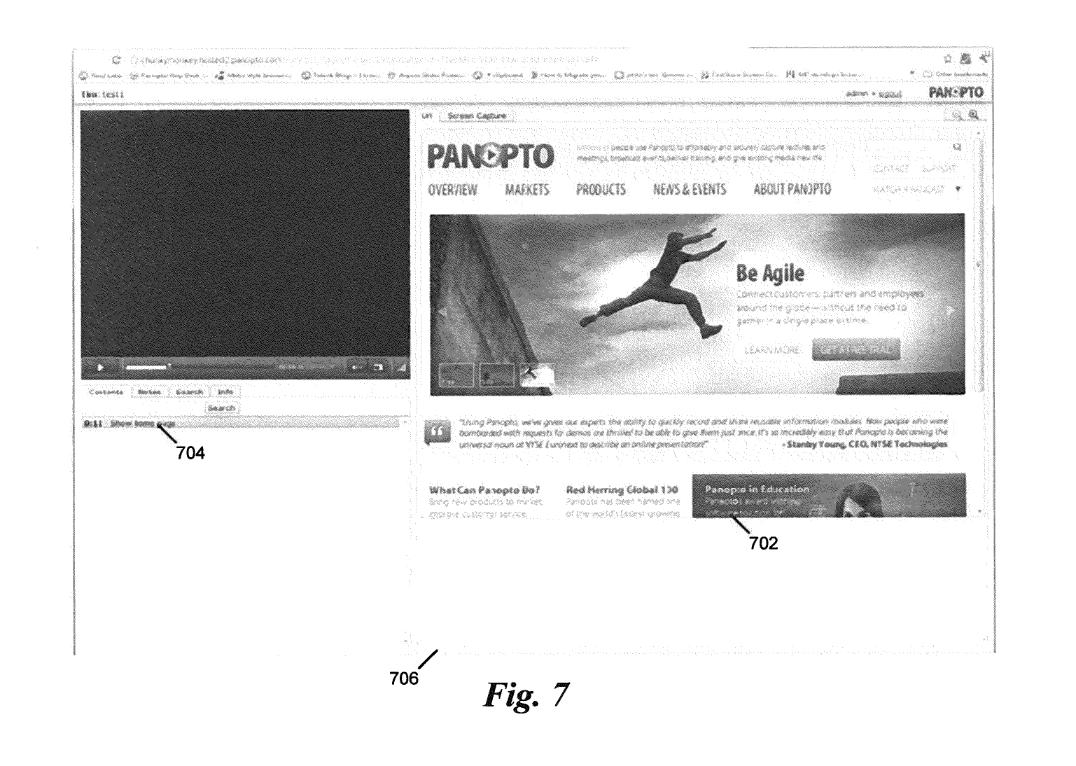

FIG. 6 depicts an example modal dialog window 602 for adding a new event to a composite video work and for associating a URL with the new event. As described above with respect to FIG. 5, a user interface may include an editor component, and the editor component may be used to invoke a dialog box from which a new URL based event can be added. The modal dialog window 602 of FIG. 6 is an example of such a dialog box and allows a user to add a new event, associate a URL with the new event, and determine a point on a session timeline with which to associate the new event. The modal dialog window 602 may appear after clicking an “Add New Event” button of a user interface 603. While the modal dialog window 602 is active, other features of the user interface 603 may be disabled, such that the user must close the modal dialog window 602 in order to regain access to the other features. Included in the modal dialog window 602 is a field 604 labeled “URL,” into which the user may input a valid URL to associate with the new event. The modal dialog window 602 further includes a field 606 for associating the new event with a time on the session timeline. As illustrated in the example dialog window 602 of FIG. 6, the new event is associated with the time at approximately the twelve second mark of the session timeline. This time value may be changed via the up and down arrow buttons included in the field 606.

The example modal dialog window 602 also includes fields 608 and 610, which enable the user to enter a caption for the new, URL based event (e.g., “Show home page”) and to input searchable metadata for the event, respectively. The caption may be used in a variety of ways with the composite work (e.g., the caption may be displayed on a screen when the new event is invoked, or alternatively, the caption may not be visible when the composite work is displayed and may only be used in conjunction with editing tasks associated with the composite work). The modal dialog window 602 further includes a preview window 612, which may be used to display a preview of the new event. If the new event is associated with a streaming video or presentation, for example, the preview window 612 may display a screen capture for the streaming video or presentation. The preview provided may be, for example, a scaled down or smaller-size (e.g., thumbnail) version of some aspect of the new event.

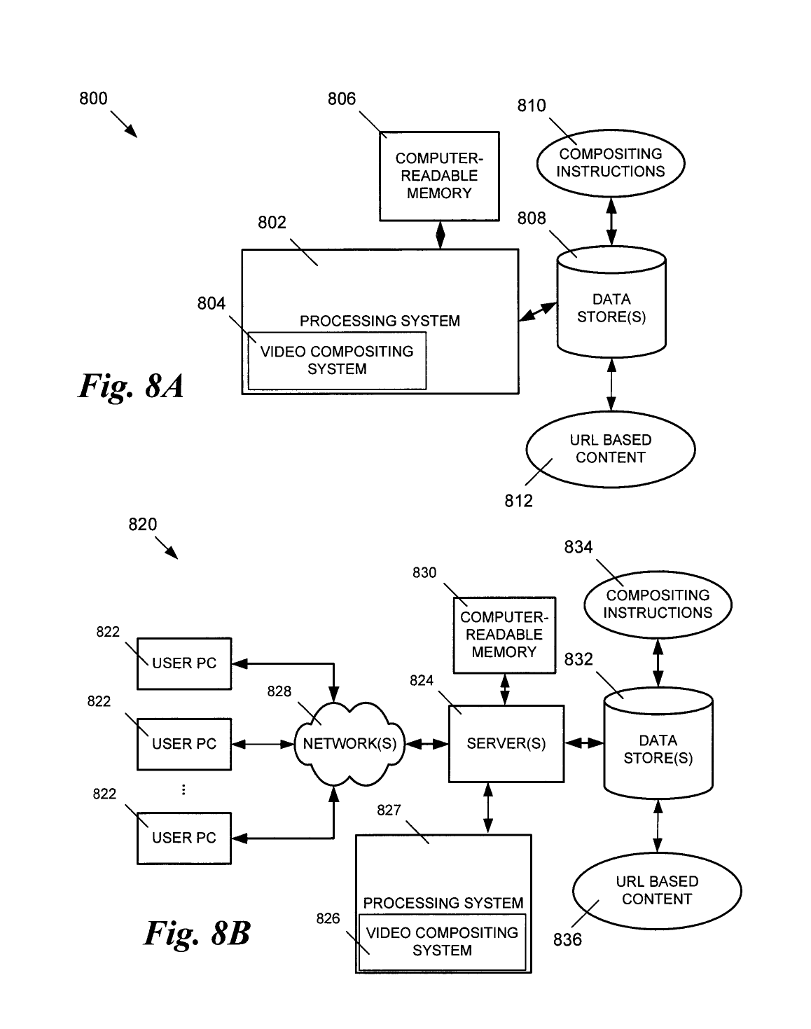

FIG. 7 depicts loading of a URL based event 702 within a viewer 706 used to display a composite work. As described above with respect to FIGS. 5 and 6, a URL based event may be integrated with a composite video work at a particular point on a timeline. This may be achieved by positioning the new URL based event at a particular point on the timeline or by inputting the particular time via a dialog box (e.g., the modal dialog window 602 of FIG. 6), among other methods. In FIG. 7, the URL based event is loaded and displayed in the viewer 706 at the exact point in the timeline associated with the event. Although FIG. 7 depicts a web page being displayed as the URL based event, in other examples, other types of content accessible via a URL address may be accessed and used as an event in the composite video work (e.g., quiz applications, experiment applications, navigation applications, streaming audio or video, Java or Javascript programs, Flash programs, etc.). Also depicted in FIG. 7 is a list of events 704 associated with the composite video work. The list includes the URL based event 702 and an indication that the event 702 is associated with an eleven second mark on the timeline. The list of events 704 further displays a caption associated with the URL based event 702, “Show home page.”

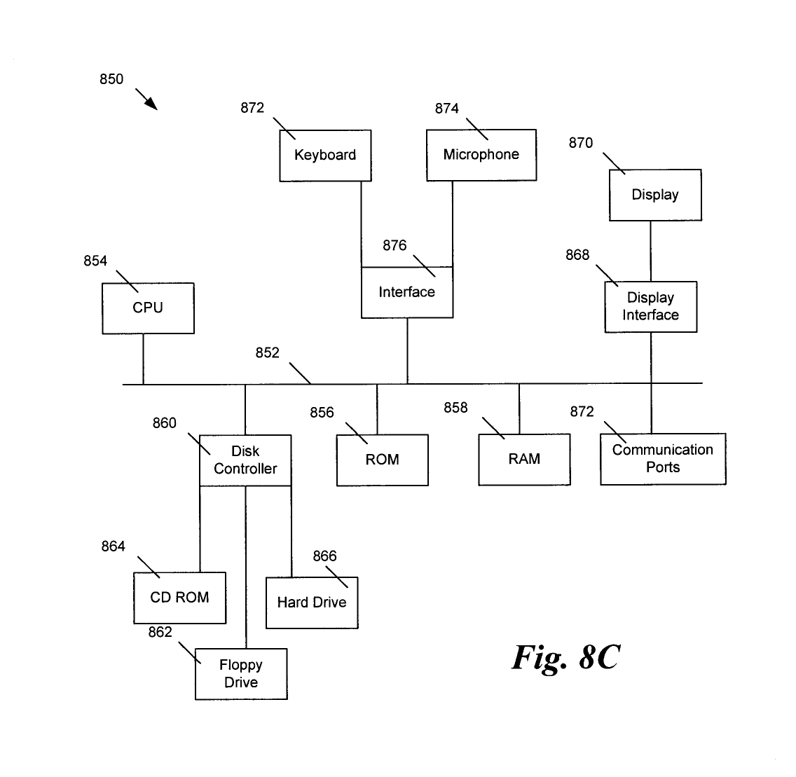

FIGS. 8A, 8B, and 8C depict example systems for video compositing. For example, FIG. 8A depicts an exemplary system 800 that includes a standalone computer architecture where a processing system 802 (e.g., one or more computer processors located in a given computer or in multiple computers that may be separate and distinct from one another) includes video compositing system 804 being executed on it. The processing system 802 has access to a computer-readable memory 806 in addition to one or more data stores 808. The one or more data stores 808 may include compositing instructions 810 as well as URL based content 812. The processing system 802 may be a distributed parallel computing environment, which may be used to handle very large-scale data sets.

FIG. 8B depicts a system 820 that includes a client-server architecture. One or more user PCs 822 access one or more servers 824 running a video compositing system 826 on a processing system 827 via one or more networks 828. The one or more servers 824 may access a computer-readable memory 830 as well as one or more data stores 832. The one or more data stores 832 may contain compositing instructions 834 as well as URL based content 836.

FIG. 8C shows a block diagram of exemplary hardware for a standalone computer architecture 850, such as the architecture depicted in FIG. 8A that may be used to contain and/or implement the program instructions of system embodiments of the present disclosure. A bus 852 may serve as the information highway interconnecting the other illustrated components of the hardware. A processing system 854 labeled CPU (central processing unit) (e.g., one or more computer processors at a given computer or at multiple computers), may perform calculations and logic operations required to execute a program. A non-transitory processor-readable storage medium, such as read only memory (ROM) 856 and random access memory (RAM) 858, may be in communication with the processing system 854 and may contain one or more programming instructions for performing the method of video compositing. Optionally, program instructions may be stored on a non-transitory computer-readable storage medium such as a magnetic disk, optical disk, recordable memory device, flash memory, or other physical storage medium.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. The processor 854 may access one or more components as required.

A display interface 868 may permit information from the bus 852 to be displayed on a display 870 in audio, graphic, or alphanumeric format. Communication with external devices may optionally occur using various communication ports 872.

In addition to these computer-type components, the hardware may also include data input devices, such as a keyboard 873, or other input device 874, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the present invention has been described in conjunction with preferred embodiments thereof, those of ordinary skill in the art will recognize that many modifications and variations are possible. Those of ordinary skill in the art will recognize that various components disclosed herein (e.g., the filter graphs, frame scheduler, timeline generator, etc.) may be implemented in software and stored on a computer readable storage medium. Other implementations may include firmware, dedicated hardware, or combinations of the above. All such modifications and variations are intended to be covered by the following claims.

What is claimed is:

1. A system for video compositing, comprising:
a storage device for storing a composite timeline file;
a timeline manager responsive to said stored timeline file for reading rendering instructions and compositing instructions;
a plurality of filter graphs, each for receiving one of a plurality of video streams and for rendering frames therefrom in response to said rendering instructions;
a uniform resource locator (URL) incorporator for generating URL based content;
hardware responsive to said rendered frames, URL based content, and compositing instructions for creating a composite image;
a frame scheduler responsive to said plurality of filter graphs for controlling a frequency at which said hardware creates a new composite image; and
an output for displaying said composite image.

2. The system of claim 1, wherein the URL based content includes an interactive application configured to accept an input from a user and to generate an output based on the input.

3. The system of claim 2, wherein the interactive application is a quiz application, an experiment application, or a navigation application, wherein the quiz application includes a quiz for the user, wherein the experiment application includes a virtual experiment for the user, and wherein the navigation application includes a learning interaction model to enable the user to access content related to the composite image.

4. The system of claim 1, wherein the URL incorporator accepts a URL address from a user, and wherein the URL based content is generated based on the URL address.

5. The system of claim 4, wherein the URL incorporator includes a whitelist of domains, the whitelist including a list domains accessible by the URL incorporator, and wherein the URL address from the user is compared against the list of domains.

6. A system for video compositing, comprising:
a storage device for storing a composite timeline file;
a timeline manager for reading said stored timeline file to identify rendering instructions and compositing instructions;
a plurality of software filter graphs, each having a rendering module for receiving one of a plurality of video streams and for rendering frames therefrom in response to said rendering instructions;
a uniform resource locator (URL) incorporator for generating URL based content;
hardware responsive to said plurality of filter graphs, time line manager, and URL incorporator for creating a composite image in response to said rendered frames, URL based content, and compositing instructions;
a frame scheduler responsive to said plurality of filter graphs for commanding said hardware to create a new composite image when any of said filter graphs renders a new frame; and
an output for displaying said composite image.

7. The system of claim 6, wherein the URL based content includes an interactive application configured to accept an input from a user and to generate an output based on the input.

8. The system of claim 7, wherein the interactive application is based on a hypertext markup language or a Javascript programming language.

9. The system of claim 8, wherein the URL incorporator includes a programming interface to the hypertext markup language or the Javascript programming language.

10. The system of claim 6, wherein the composite image is included in a composite video work, and wherein the URL based content is associated with an event of the composite video work.

11. A method for video compositing, comprising:
reading rendering instructions and compositing instructions from a timeline file;
rendering frames from a plurality of video streams in response to said rendering instructions;
generating uniform resource locator (URL) based content;
creating a composite image from said rendered frames, URL based content, and compositing instructions;
controlling a frequency at which a new composite image is created in response to said rendering; and
displaying said composite image.

12. The method of claim 11, further comprising:
creating a composite video work based on the composite image; and
associating the URL based content with a point in time on the timeline file or with an event of the composite video work.

13. The method of claim 11, further comprising:
accepting a URL address from a user, wherein the URL based content is generated based on the URL address.

14. The method of claim 13, further comprising:
comparing the URL address from the user with a whitelist of domains, the whitelist of domains including a list of accessible domains for generating the URL based content.

15. The method of claim 11, wherein the URL based content includes an interactive application configured to accept an input from a user and to generate an output based on the input.

16. The method of claim 15, wherein the interactive application is a quiz application, an experiment application, or a navigation application, wherein the quiz application includes a quiz for the user, wherein the experiment application includes a virtual experiment for the user, and wherein the navigation application includes a learning interaction model to enable the user to access content related to the composite image.

17. The method of claim 15, further comprising:
exposing a programming interface to a programming language of the interactive application.

18. The method of claim 17, wherein the programming language is based on a hypertext markup language or a Javascript programming language.

19. A computer readable memory device, carrying a set of instructions which, when executed, performs a method comprising:
reading rendering instructions and compositing instructions from a timeline file;
rendering frames from a plurality of video streams in response to said rendering instructions;
generating uniform resource locator (URL) based content;
creating a composite image from said rendered frames, URL based content, and compositing instructions;
controlling a frequency at which a new composite image is created in response to said rendering; and
displaying said composite image.

20. A computer readable memory device, carrying a set of instructions which, when executed, performs a method comprising:
generating rendering instructions using metadata to identify one or more video segments from a plurality of video media streams;
generating compositing instructions for controlling the presentation of video segments identified by said rendering instructions;
generating URL based content; and
storing said rendering instructions, compositing instructions, and URL based content.
